(19) United States
(12) Patent Application Publication
(10) Pub. No.: US 2026/0134163 A1
(43) Pub. Date: May 14, 2026

(54) PREDICTING FEASIBLE DESIGNS FOR A PHYSICAL SYSTEM

(71) Applicant: Secondmind Limited, Cambridge (GB)

(72) Inventors: Hrvoje STOJIC, Cambridge (GB); William COWLEY, Cambridge (GB); Alessandro VULLO, Cambridge (GB); Victor PICHENY, Cambridge (GB)

(21) Appl. No.: 19/430,120

(22) Filed: Dec. 22, 2025

Related U.S. Application Data
(63) Continuation of application No. PCT/GB2024/051628, filed on Jun. 26, 2024.

(30) Foreign Application Priority Data
Jun. 28, 2023 (GB) 2309750.4

(51) Int. Cl. G06F 30/15; G06F 30/20; G06F 111/10

(52) U.S. Cl. CPC G06F 30/15; G06F 30/20; G06F 2111/10

(57) ABSTRACT

Predicting a feasible region of a design space for a physical system includes, for one or more iterations, determining a set of design points. The determining includes, for outputs of the physical system, sampling respective functions from respective probabilistic models, wherein the respective functions predict values of the outputs at design points, and selecting a design point based on an objective function that penalises a distance from a boundary of the feasible region as predicted by values of the respective functions. The selecting of at least some design points is performed in parallel. At each iteration, data is obtained comprising empirical values of the output(s) at the determined design points, and using the obtained data to determine updated values of trainable parameters of the model. The method includes, after the one or more iterations, predicting the feasible region using the data obtained during the one or more iterations.

This application is a continuation under 35 U.S.C. § 120 of International Application No. PCT/GB2024/051628, filed Jun. 26, 2024, which claims priority to United Kingdom Application No. GB 2309750.4, filed Jun. 28, 2023, under 35 U.S.C. § 119 (a). Each of the above-referenced patent applications is incorporated by reference in its entirety.

### TECHNICAL FIELD

The present disclosure relates to predicting feasible regions of a design space for a physical system. The disclosure has particular, but not exclusive, relevance to predicting feasible regions of a design space for a vehicle.

### BACKGROUND

Design of a complex system such as a vehicle typically begins with a definition of top-level requirements and constraints, then proceeds to progressively more detailed definitions of lower-level subsystems and components. Following this design phase, integration and testing start at the bottom-level components, progressively building back up to the top-level system. This is referred to as the “V model” of a system development lifecycle.

During the design phase, feedback from downstream (lower-level) stages is iteratively provided to upstream (higher-level) stages until a set of designs of subsystems and components is determined. If a low-level subsystem or component is unable to meet requirements as imposed by a higher level component, system or subsystem, then the higher-level design may need to be modified. This may, in turn, change the requirements on other lower-level subsystems or components as they compensate for the modification. This can result in costly reworks and delays in development.

Set-based design is a design paradigm in which, rather than fixing on a single design early on in the design process, design decisions are delayed until a late stage in the design process when more information is available. At a given stage of the process, a feasible set of designs is predicted, for example using simulation tools, providing flexibility to deal with uncertainties or adjustments in lower-level components or subsystems if and when they arise. In this way, reworks may be avoided, and development time reduced. A problem with this approach is that, for complex physical systems, the simulation tools used to predict the feasibility of designs at each stage are often very computationally expensive and time-consuming to run. Furthermore, a large number of simulation runs may be required to uncover the feasible set of designs, particularly if the dimensionality of the design space is large. Due to these challenges, companies can be prevented from reaping the benefits of less reworking and delays in later stages of the system development lifecycle.

### SUMMARY

According to an aspect of the present disclosure, there is provided a computer-implemented method of predicting a feasible region of a design space for a physical system. The method includes, for one or more iterations, determining a set of design points within the design space. Determining a given design point in the set includes, for one or more outputs of the physical system, sampling respective functions from respective probabilistic models each having a set of trainable parameters, wherein the respective functions predict values of the one or more outputs at design points within the design space, and selecting the given design point based on an objective function that penalises a distance from a boundary of the feasible region as predicted by values of the respective functions. The selecting of at least some of the design points in the set is performed in parallel. At each iteration, the method includes obtaining data comprising values of the one or more outputs of the physical system at each design point of the determined set of design points, and using the obtained data to determine updated values of the set of trainable parameters. The method includes, after the one or more iterations, predicting the feasible region of the design space using the data obtained during the one or more iterations.

The one or more outputs of the physical system may be subject to respective constraints, and the feasible region may be a region of the design space in which the respective constraints for the one or more outputs of the physical system are all satisfied. By sampling the respective functions from the respective probabilistic models and independently selecting the design points based on predictions provided by the respective functions, determining the set of design points can be parallelised across potentially many nodes or processor cores. At each iteration, an arbitrarily large number of design points can be determined in a highly efficient manner with a processing cost that scales only linearly with the number of points. The determined design points are predicted by the probabilistic model(s) to lie close to the boundary of the feasible region, so that the method automatically progresses from exploring a large proportion of the design space at early iterations to concentrating on the most informative parts of the design space (i.e. near the ground truth boundary of the feasible region) at later iterations. As a result, the feasible region of the design space may be uncovered using relatively few rounds of empirical and/or simulated data collection.

Predicting the feasible region of the design space may use the respective probabilistic model(s) for the one or more outputs of the physical system. Alternatively, the data collected during the one or more iterations may be used to predict the feasible region of the design space without further use of the probabilistic model(s), for example by providing the data to another model or algorithm. The data may for example be used to generate a representation or estimate of a boundary of the feasible region.

The boundary of the feasible region may depend on a variable threshold value of one of the outputs of the physical system, and selecting the given design point may include sampling the variable threshold value from a distribution of threshold values to predict the distance from the boundary of the feasible region. In this way, the method can account for uncertainty in the variable threshold value when determining the set of design points, allowing the value of the threshold to be fixed at a later stage. The distribution may for example be a uniform distribution over a given range of threshold values, or may be a nonuniform distribution such as a Gaussian distribution. The resulting prediction of the feasible region is flexible and robust to a change of the variable threshold value within a range corresponding to the distribution. In the case of a uniform distribution, the trained models are expected to be, on average, equally accurate for any threshold value in the given range.

Obtaining the data may include executing simulations of the physical system at the determined set of design points or taking physical measurements of the physical system, or of one or more mock-ups of at least part of the physical system. The obtaining of the data may be performed in parallel for at least some of the design points in the set. By obtaining the data in parallel, the method can take advantage of the fact that multiple design points are determined at each iteration and thereby significantly reduce the amount of time needed for the data collection phase at each iteration.

The probabilistic model may include at least one of a sparse Gaussian process, a deep Gaussian process, a Bayesian neural network, and a deep ensemble. All of these models are capable of predicting probability distributions of the output of the physical system, and all are capable of operating in a large data regime, for example with thousands to millions of design points. The inventors have discovered that deep Gaussian process models and deep ensembles are particularly well-suited to settings in which the output of the physical system exhibits one or more discontinuities. Nevertheless, “exact” Gaussian process regression (GPR) models may be suitable in small data regimes for the sake of accuracy. In a particular example, GPR models may be used at early iterations while the volume of obtained data is still relatively low, then switched to one or more other types of model when the volume of data renders GPR models unviable in terms of processing resources, memory, or time.

Selecting the design point may include sampling a plurality of candidate design points from within the design space, updating each of the plurality of candidate design points so as to reduce a corresponding value of the objective function, and selecting one of the updated candidate design points based on the corresponding values of the objective function after the updating. In this way, the selected design point is likely to correspond to a global minimum of the objective function as predicted by the sampled function, thus avoiding potentially uninformative design points resulting from local minima of the sampled function. In other examples, alternative optimisation algorithms may be used for selecting the design point, for example an evolutionary algorithm or by comparing evaluations of the objective function on a regular grid.

For a given iteration, determining each design point in the set may include optimising a respective objective function within a respective trust regions of the design space, the respective trust regions differing between at least some design points in the set. This may lead to more efficient exploration of the boundary of the feasible region, particularly for high-dimensional design spaces.

For a given iteration, determining each design point in the set uses a respective group of one or more probabilistic models, the respective groups corresponding to the respective trust regions of the design space. In this way, each group of probabilistic model(s) may only be responsible for modelling a relatively small region of the design space, rather than modelling the entirety of the design space as is the case if a common group of probabilistic model(s) is used for all of the design points in the set. This may result in further improved accuracy of the method and improved scalability to high-dimensional design spaces.

The method may include determining that a distance between two design points of the determined set of design points is less than a threshold distance, and replacing one of the two design points with a replacement design point sampled from a replacement point distribution. By replacing design points that are very close to one another in the design space, the method avoids wastefully gathering duplicated information. The replacement point distribution could be, for example, a normal distribution or other probability distribution centred at the original design point (possibly truncated so as not to extend beyond an appropriate domain). Alternatively, the replacement point distribution could be independent of the original point, for example being a uniform distribution, in which case any duplicated design points could be replaced with a randomly sampled point predicted by the probabilistic model(s) to be close to the feasible region boundary. In another example, at a given iteration a relatively large initial set of design points may be obtained, from which a subset may be selected algorithmically in such a manner to avoid any two design points in the subset being too close to one another.

The method may include obtaining a plurality of design points predicted or measured to lie within the feasible region of the design space, and bounding the plurality of design points using a set of geometric shapes of equal dimensionality to the design space to determine a representation of the feasible region of the design space. For many physical systems, the design space can be high-dimensional, meaning that extracting useful information about the predicted feasible region can be challenging. Determining the representation of the feasible region using high-dimensional geometric shapes enables sets of feasible design points to be identified without requiring a human user to exhaustively inspect the high-dimensional space in a manual or visual way. The determined representation may be used to determine various characteristics of the feasible region that may be pertinent for downstream processes. The plurality of design points may be obtained for example by evaluating the respective probabilistic models for the one or more design points, and/or based on the data obtained during the plurality of iterations.

The physical system may include at least part of a vehicle, for example including one or more of a hybrid powertrain system, a vehicle architecture, an electric motor, a battery system, a thermal management system, a regenerative braking system, a tyre, and an aerodynamic component. More generally, the present methods may be used to assist with design of entire systems (such as vehicles) and/or subsystems or components at any level in a set-based design process.

According to a further aspect, there is provided a computer-implemented method of determining a representation of a feasible region of a design space for a physical system. The method includes obtaining a plurality of design points predicted or measured to lie within the feasible region of the design space, and bounding the plurality of design points using a set of geometric shapes (for example hyper-ellipsoids or hyper-rectangles) of equal dimensionality to the design space to determine the representation of the predicted feasible region of the design space.

Determining the representation of the feasible region using high-dimensional geometric shapes enables sets of feasible design points to be identified without requiring a human user to exhaustively inspect the high-dimensional space in a manual or visual way.

The plurality of design points may be an intermediate set of design points, and bounding the plurality of design points using the set of geometric shapes may include bounding the intermediate set with an intermediate geometric shape of equal dimensionality to the design space, then iteratively, for the or each intermediate set: applying a clustering algorithm in dependence on the intermediate geometric shape to split the intermediate set into a plurality of intermediate sets, bounding each of the plurality of intermediate sets with a respective intermediate geometric shape, and in the event that a volume of the design space occupied by the respective intermediate geometric shapes after the splitting is no less than a volume of the design space occupied by the intermediate geometric shape before the splitting, adding the intermediate geometric shape before the splitting to the set of geometric shapes. The sets of shapes rapidly converge towards a set which corresponds closely to the feasible region of the design space.

Obtaining the plurality of design points predicted or measured to lie within the feasible region of the design space may include obtaining respective models for one or more outputs of the physical system, and evaluating the respective models for the one or more the outputs at a plurality of design points in the design space to predict the plurality of design points lying within the feasible region of the design space.

The method may include determining, using the set of geometric shapes, an uninterrupted at least part of the feasible region of the design space, for example by identifying a connected at least subset of the set of geometric shapes. Such uninterrupted regions may be of particular interest as they define individual feasible sets in which a design process can take place.

The method may further include determining, for the uninterrupted at least part of the feasible region of the design space, at least one of a hypervolume, an exterior axis-aligned bounding box, and a largest interior axis-aligned bounding box. These features may be of particular importance for the design process. For example, the largest interior axis-aligned bounding box may determine a set of mutually independent constraints on individual design parameters, meaning that those design parameters can be varied independently within the corresponding ranges. Information indicative of any of these features may for example be output via a user interface or may be provided as an input to an automated downstream design process.

According to further aspects, there are provided a data processing system comprising means for carrying out any one of the above methods, and a computer program product (such as one or more non-transient storage media) comprising instructions which, when the program is executed by a computer, cause the computer to carry out any one of the above methods.

According to a further aspect, there is provided a method including predicting a feasible region of a design space for a physical system using any of the above methods of predicting a feasible region, and manufacturing a prototype of the physical system with values of the design parameters falling within the predicted feasible region of the design space.

According to a further aspect, there is provided a method including determining a representation of a feasible region of a design space for a physical system using any of the above methods of determining a representation of a feasible region, and manufacturing a prototype of the physical system with values of the design parameters falling within the feasible region of the design space as indicated by the determined representation of the feasible region.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 schematically shows a system for predicting a feasible region of a design space for a physical system.

FIG. 2 shows an illustration of a feasible set of designs within a design space.

FIG. 3 schematically shows a method of predicting a feasible region of a design space for a physical system.

FIG. 4 illustrates functions being sampled from a probabilistic model of an output of a physical system.

FIG. 5 illustrates distributions of sampled design points around a threshold value of an output, using two different sampling techniques.

FIG. 6 shows two-dimensional plots showing characteristics of feasible regions of a six-dimensional design space.

FIG. 7 is a flow chart representing a computer-implemented method of determining a representation of a feasible region of a design space for a physical system.

FIGS. 8A-8E illustrate representations of a feasible region of a design space based on a set of geometric shapes.

FIG. 9 is a flow chart representing a computer-implemented method of bounding a set of design points using a set of geometric shapes.

FIGS. 10A-10E illustrate a method of bounding the set of design points of FIGS. 8A-8E using a set of geometric shapes.

### DETAILED DESCRIPTION

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Embodiments of the present disclosure relate to set-based system design. In particular, embodiments described herein address challenges related to the time-consuming and resource-intensive nature of running simulations of a complex physical system, which can be a major bottleneck in the development cycle of the physical system.

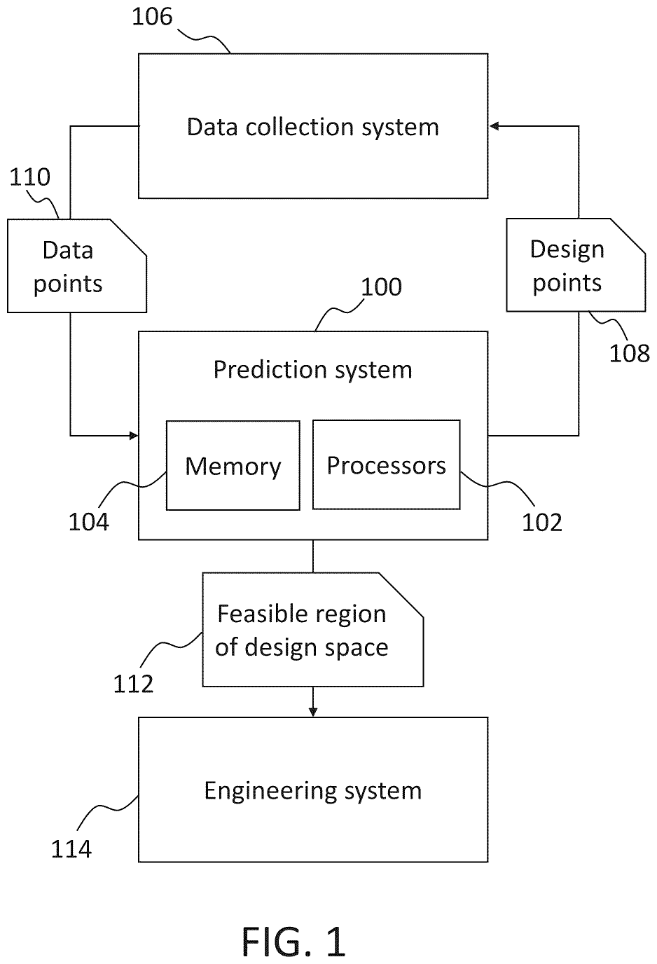

FIG. 1 schematically shows a prediction system 100 for predicting a feasible region of a design space for a target physical system. The target physical system could be a vehicle, such as a car, motorbike, lorry, truck, boat, aircraft, unmanned ariel vehicle (UAV) or drone, or a component thereof, such as an internal combustion engine, electric motor, or hybrid powertrain for a vehicle. Alternatively, the target physical system could be, or include, one or more of a hydraulic system, an electrical system or any other system to be designed. The target physical system may be formed of a hierarchy of subsystems and components, and the prediction system 100 may similarly be used to predict feasible regions for a design space for a subsystem or component at any level in the hierarchy. The design of the target physical system may be undetermined at the time when the methods described herein are carried out, and the target physical system may not physically exist at the time when the prediction system 100 is operated.

The design space for the target physical system may be parameterised by a number of design parameters (for example tens or hundreds of design parameters). A design point within the design space may designate a respective value for each of the design parameters. The target physical system has one or more outputs that may depend on the values of the design parameters. In the context of the target physical system being a vehicle or a component of a vehicle, examples of outputs include carbon dioxide emissions, fuel consumption, maximum speed, and time to accelerate from zero to a given speed such as 100 km/h. Generally speaking, an output may be any function or combination of quantities whose values may be measured experimentally or determined from a numerical simulation. A given output may be continuous or discrete, for example a binary output may indicate directly whether a given design point causes a numerical simulation of the target physical system to produce valid output values, rather than nonsensical output values and/or an error. One of the functions of the predictions system 100 is to predict values of the one or more outputs for a given set of values for the design variables for the target physical system. In order to do so, the prediction system 100 includes one or more probabilistic models capable of predicting, for a given design point, probability distributions for the one or more outputs of the target physical system. In some examples, a multi-output probabilistic model may be configured to predict probability distributions for some or all outputs of the target physical system. In other examples, separate probabilistic models may be provided for separate outputs of the target physical system. The probabilistic model(s) may be used to model the outputs directly, or may be used to model residuals of a simple regression model such as a linear regression model. This latter approach effectively detrends the outputs of the target physical system, which the inventors have found can improve the accuracy of the probabilistic model(s) in modelling the outputs.

The (or each) probabilistic model may be any one of a sparse Gaussian process, a deep Gaussian process, a Bayesian neural network, an ensemble of neural networks (so-called deep ensemble), and/or a combination of any of these models. These models remain computationally tractable for large numbers of data points (for example tens of thousands, hundreds of thousands, or millions of data points), in contrast with standard Gaussian process regression models. Nevertheless, in other examples a standard Gaussian process regression model may be used, or any other type of probabilistic model capable of predicting probability distributions over functions corresponding to outputs of a physical system. In the case of a discrete output, the corresponding probabilistic model may be a classification model. In the case of a continuous output, the corresponding probabilistic model may be a regression model.

The inventors have found that deep Gaussian process models and deep ensembles, in particular, are capable of faithfully capturing the probability distribution of outputs even when the outputs exhibit discontinuities across certain manifolds within the design space. Sparse or deep Gaussian process models may optionally employ heteroskedastic likelihoods to assist the models in capturing varying levels of observation noise at different regions of the design space, as described in the article “Chained Gaussian Processes” by Saul et al., Proceedings of the 19th International Conference on Artificial Intelligence and Statistics (2016). In some examples, a multi-output probabilistic model may be configured to predict probability distributions for some or all outputs of the target physical system. In some examples, separate probabilistic models may be provided for separate outputs of the target physical system.

The outputs of the target physical system may be subject to constraints. For the purpose of clarity, only upper thresholds are considered in the present disclosure, but the methods described herein may be generalised to handle other types of constraint. For example, a lower threshold may be converted to an upper threshold by inverting the corresponding output. Furthermore, a monotonic transformation may be applied to an output to convert a constraint to an upper threshold. The transformation may be predetermined or may be learned along with the parameter values of the corresponding probabilistic model. Nevertheless, in other examples lower thresholds (or bounded ranges having both upper and lower thresholds) may be explicitly considered. A feasible design for the target physical system may be defined as a set of values for the design parameters for which all of the constraints are satisfied. In the event that the constraint(s) are formulated as upper threshold(s), a feasible design may be one for which none of the threshold(s) are exceeded. The thresholds may be known a priori, for example from modelling, simulation, and/or experiments performed before the design process takes place, or due to regulations. Alternatively, a range of values for a given threshold may be provided initially, and an exact value only determined at a later stage, for example as a result of information gleaned from experiments or simulations performed during the design or testing processes. Further, a user may iterate and change the thresholds or ranges of thresholds as the learning process progresses. An overarching objective of the prediction system may be to assist with determining a feasible set of designs for the target physical system.

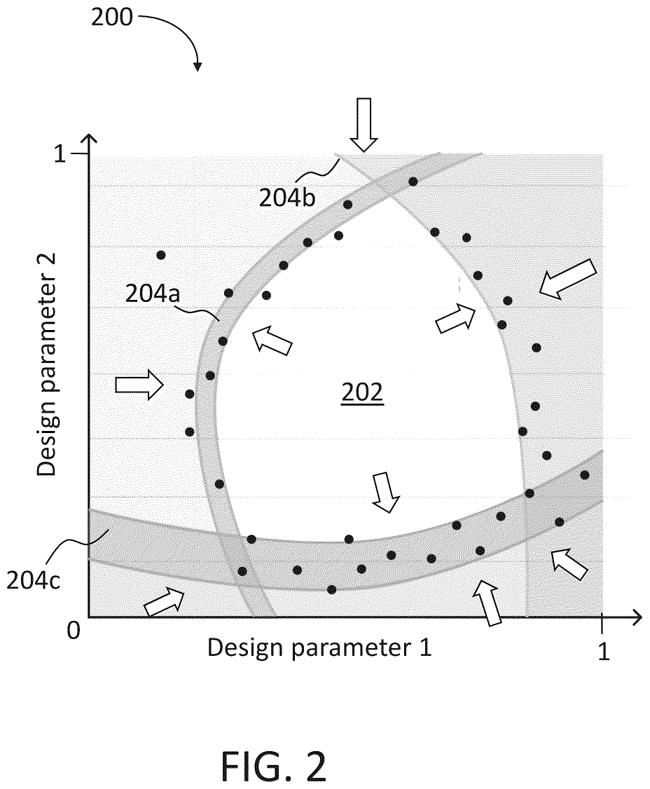

FIG. 2 shows an illustrative example of a design space 200 for a target physical system with two design parameters and three outputs. In other examples, the number of design parameters and/or the number of outputs may be significantly greater. The design space 200 includes a feasible region 202 bounded by three boundary regions 204a, 204b, 204c each corresponding to a threshold on a respective output of the target physical system. The regions 204a and 204c have non-zero widths, indicating that the corresponding thresholds are not known exactly in advance of the design process and a range of thresholds has been provided instead. When the thresholds are fixed, for example at a later testing stage, the three boundaries of the feasible region 202 will lie somewhere in the regions 204a, 204b, 204c. The lack of certainty about these boundaries introduces a challenge in the design process, as it necessitates determining information about the feasibility of design points throughout the finite-width boundary regions.

The prediction system 100 includes processors 102 and memory 104. The processors 102 may include one or more of each of a central processing unit (CPUs), graphics processing unit (GPU), neural processing unit (NPU), neural network accelerator (NNA), application-specific integrated circuit (ASIC), application-specific standard product (ASSP), digital signal processor (DSP), field programmable gate array (FPGA), system-on-chip (SoC), any other suitable form of integrated circuit. The prediction system 100 may be a single device or may include multiple devices or systems communicating with one another via a network. The processors 102 include multiple processing nodes, which may include separate cores of a single processor and/or may include multiple processors within a single device or distributed across multiple devices. In the present disclosure, the term memory is used to encapsulate both volatile and non-volatile working memory, as well as non-volatile storage. The memory 104 stores data obtained during the operation of the prediction system 100, as well as computer-readable instructions in any suitable format for implementing the methods described herein.

The prediction system 100 is communicatively connected to a data collection system 106. The data collection system 106 may include one or more computing devices. The data collection system 106 and the prediction system may be part of a single device or system, or may be separate from one another. For example, the prediction system 100 and the data collection system 106 may be operated by different commercial entities, in which case the prediction system 100 may be configured to provide functionality to the operator of the data collection system 106 via a software-as-a-service or cloud-based model. The data collection system 106 is arranged to obtain data representing values of the one or more outputs of the target physical system. The data collection system 106 may for example be configured with software to run numerical simulations of the target physical system. Advantageously, the data collection system 106 may be capable of running many instances of a numerical simulation in parallel with one another, with each instance using a respective set of values for the design points. Such simulations may be based on, for example, finite element method (FEM), boundary element method (BEM), finite difference method (FDM), discrete element method (DEM), and/or discrete event-based simulation. The simulations may be deterministic such that a given set of inputs always produces the same set of outputs, or may include a degree of randomness or pseudo-randomness, for example to account for noise. In the present disclosure, values of the one or more outputs may include simulated values of the one or more outputs, and/or may include physical measurements of the one or more outputs, for example obtained from a prototype of the target physical system. The data collection system 106 may be fully automated, or its operation may involve some manual input from users such as test engineers.

Obtaining values of the output(s) of the target physical system can be a highly time-consuming and resource-intensive process. In particular, numerical simulation of complex systems can require many hours or even days of processor time to execute. Similarly, building and adjusting physical prototypes can be highly expensive in terms of materials and labour. It is therefore desirable to determine a feasible region of the design space for the target physical system using only a relatively small volume of empirical and/or simulated data. In order to facilitate this goal, the prediction system 100 and the data collection system 106 take part in an iterative process to uncover the feasible region of the design space. In each iteration, the prediction system 100 determines a set of design points 108 for the target physical system and provides the set of design points 108 to the data collection system 106. Each design point (or query point) corresponds to a respective design or configuration of the target physical system. The set of design points 108 may be provided in any suitable format, for example a comma separated values (CSV) file with entries corresponding to values of the design parameters for each design point. The set of design points 108 may include tens, hundreds, or thousands of design points. The design points may have coordinates restricted to a predetermined domain, for example within the range [0,1] for each dimension of the design space. The design points may include continuous and/or discrete input dimensions. In some examples, the design parameters may include one or more categorical variables, in which case a mapping of the categorical variables to a (latent) input dimension of the design space may be learned alongside parameter values of the probabilistic model(s).

For each design point in the set of design points 108, the data collection system 106 obtains a set of data points 110, each data point indicating values of the one or more outputs of the target physical system for a respective one of the design points 108. The data collection system 106 provides the data points 110 to the prediction system 100, for example as a further CSV file. The values of the outputs may be normalised to lie within or close to a given range, for example the range [0,1]. Data transmitted between the prediction system 100 and the data collections system 106 may be validated at each iteration, for example to ensure the data has the expected format, includes the expected number of data points, and the values lie within the expected domains and/or ranges. Other processing may be performed, such as normalisation, outlier removal, and so on.

At each iteration, the design points 108 and the data points 110 may be transferred between the prediction system 100 and the data collection system 106 by transmitting data electronically over a network, for example via an application programming interface (API), or by email or any other suitable form of electronic communication. The transmitting may be automated or performed manually by a human user. In other examples, data indicative of the set of design points 108 and/or the data points 110 may be transferred via a wired connection between the prediction system 100 and the data collections system 106, or by manual transfer of data using a removable data storage device. The time taken by the prediction system 100 and the data collection system 106 to carry out their respective tasks may be of the order of several days for each iteration.

As will be explained in more detail hereinafter, the prediction system 100 determines design points which provide a high degree of information about the boundaries of the feasible region of the design space. At early iterations, when the prediction system 100 has received few data points from the data collection system 106, and therefore has relatively little information about the dependence of the outputs of the target physical system on the design variables, the design points determined by the prediction system exhibit a high degree of random variance. At later iterations, when the prediction system 100 has received more data points from the data collection system 106 and therefore has more information about the dependence of the outputs of the target physical system on the design variables, the prediction system 100 will determine design points close to the boundaries of the feasible region, as predicted by the one or more probabilistic models. In this way, the prediction system 100 takes account of the exploration/exploitation dilemma problem in a principled and efficient manner.

After a certain number of iterations of the iterative process involving the prediction system 100 and the data collection system 106, the prediction system 100 generates data 112 indicative of a feasible region of the design space for the target physical system, as predicted by the one or more probabilistic models. This may be done for example when certain stopping criteria are satisfied or in response to user input. The data 112 may indicate, for example, predicted boundaries of the feasible region, and/or another suitable representation of the feasible region. Methods of determining a representation of a feasible region of a design space are described in more detail hereinafter. The data 112 may be provided to an engineering system 114, which may perform a number of functions in relation to the predicted feasible region, such as displaying information about the feasible region via a graphical user interface (GUI) or generating control data for an automated manufacturing process. In other examples, the data 112 indicative of the predicted feasible region of the design space may be provided for use in a downstream design process, for example to design a lower level component or subsystem of the target physical system. In that case, the prediction system 100 may be deployed again to predict a feasible region of the design space for the lower level component or subsystem, and so on for subsequent lower level components or subsystems.

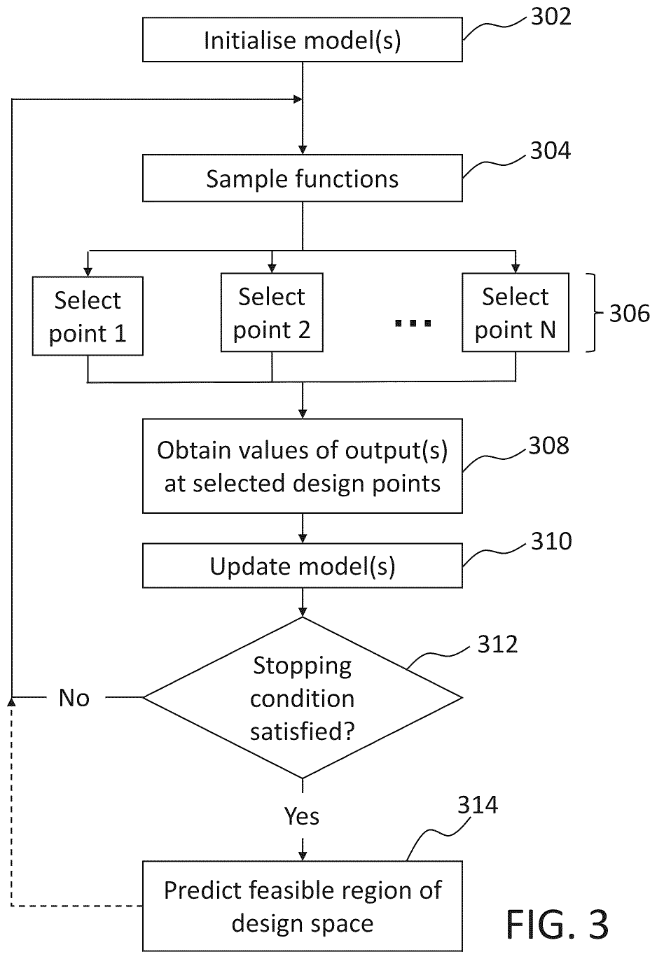

FIG. 3 shows an example of a method of predicting a feasible region of a design space for a physical system, such as the target physical system of FIG. 1. The method may be carried out, for example, by the prediction system 100. The method proceeds with initiating, at 302, one or more probabilistic models. Initialising the probabilistic model(s) may include determining initial values for trainable parameters of the probabilistic model(s), such as connection weights and/or biases in the case of a Bayesian neural network or a deep ensemble, or inducing variables in the case of a sparse Gaussian process or a deep Gaussian process. Initialising the probabilistic model(s) may further include setting values of trainable or fixed hyperparameters, such as kernel hyperparameters in the case of a sparse Gaussian process or a deep Gaussian process. The trainable parameters may be initialised with random values, for example sampled from a uniform distribution over a suitable range of values or any other suitable distribution, or may be initialised with values dependent on previous design processes.

An optional additional stage of initialisation includes sampling an initial set of design points within a suitable domain of the design space (for example a hypercube). The initial set of design points may be sampled randomly, for example using uniform sampling or any other random sampling method, or may be sampled in a deterministic fashion, for example according to a space-filling method such as Sobol sampling. Values of the output(s) of the physical system at the initial set of design points may then be obtained, for example using numerical simulations. The values of the trainable parameters of the probabilistic model(s) may then be determined to best fit the probabilistic model(s) to the obtained values of the output(s). This may for example include maximising an evidence lower bound (ELBO) of the obtained values using reverse-mode differentiation and stochastic gradient descent or a variant thereof.

The method continues by sampling, at 304, functions from the probabilistic model(s). Each probabilistic model may be viewed as probability distribution over functions, meaning that a single function can be sampled from the probabilistic model analogously to how a single point can be sampled from a finite-dimensional probability distribution. Each sampled function predicts values of one or more outputs of the physical system for design points within the design space. Sampling a function does not necessarily require determining values of the function for design points throughout the design space, but may include determining values of one or more variables that fix values of the function for design points throughout the design space. For certain types of probabilistic model, exact sampling of functions may not be possible, in which case approximate sample functions may be obtained. In the case of Gaussian process models, approximate sample functions may be obtained for example using the decoupled sampling approach set out in the article “Efficiently sampling functions from Gaussian process posteriors” by Wilson et al, International Conference on Machine Learning (2020)”. In examples where different probabilistic models are used for different outputs, or different groups of outputs, of the physical system, the sampled functions may be grouped so that a given group predicts values of each of the outputs of the physical system for design points within the design space. In the case that a batch of N design points is to be determined and J outputs of the physical system are considered, a set of functions

$${f}_{j}^{( n )}$$

may be sampled for j=1, . . . , J, n=1, . . . , N, where the functions for a given value of n may be sampled from a single multi-output model or from n_{f} independent single- or multi-output models for 1<n_{f}≤J.

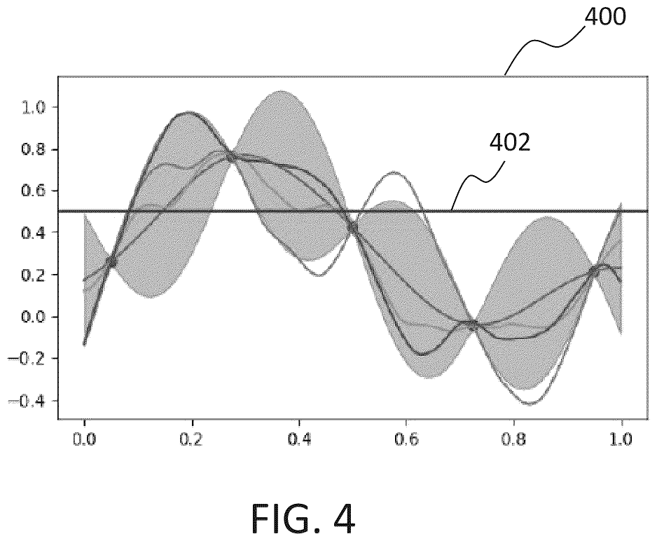

FIG. 4 shows an illustrative plot 400 of a probabilistic model of an output of a physical system with a single design variable (i.e. a single input dimension), assuming deterministic data. The shaded area of the plot represents two standard deviations of the probabilistic model. In this example, it is observed that the standard deviation drops to zero at each data point of a set of data points, indicating that values of the output are known at these points so there is no uncertainty in the output at these points. The curves passing through the data points are functions sampled from the probabilistic model, and the horizontal line 402 represents a threshold value of the output.

The method of FIG. 3 continues with selecting, at 306, design points using the sampled functions

$${f}_{j}^{( n )} .$$

In this example, design points n=1, . . . , N are selected, with the n^{th} design point being selected based on an objective function evaluating the sampled functions

$${f}_{j}^{( n )} for j = 1 , … , J .$$

The objective function may penalise a difference or distance between a threshold value for a given output and a prediction of the given output provided by the sampled function. Selecting the design points based on the objective function may include performing an optimisation routine to find a design point where the objective function is close to an extremum (for example corresponding to a minimum distance between the threshold value and the sampled function output). The n^{th} selected design point satisfy xₙ∈argminₓ d⁽ⁿ⁾(x), where d⁽ⁿ⁾(x) is the objective function for the n^{th} design point. There may be an infinite number of solutions for xₙ, for example lying along a predicted boundary of the feasible region. In that case, the choice of optimisation routine will determine which design point is selected. Those skilled in the art will be aware of suitable optimisation algorithms for this purpose, such as L-BFGS-B, CMA-ES, differential evolution, or any other suitable optimisation algorithm. In some examples, an optimiser may be run several times (for example tens, hundreds or thousands) starting from different random locations in the design space, resulting in several candidate design points. A design point may then be selected from the candidate design points, for example randomly and/or based on the values of the objective function and/or depending on the variance of the probabilistic model(s) and/or in a manner to ensure diversity among selected design points.

In some examples, further steps may be taken to avoid duplication of design points within a batch, and optionally also in relation to points in previous batches. In this regard, design points that are too close to one another may result in redundant and resource-wasteful identical observations, particularly in cases where data is collected using a deterministic simulator with limited precision. To avoid this, if a duplicate design point is detected (i.e. determined to be too close to another design point), the duplicate design point may be replaced by a replacement design point sampled from a replacement point distribution. The replacement point distribution may depend on the location of the duplicate design point, for example being a normal distribution centred at the duplicate design point and truncated so as not to extend beyond the design space. Alternatively, the replacement point distribution could be independent of the duplicate design point. In this case, a set of candidate replacement design points may be sampled randomly (e.g. uniformly) within the design space, and then filtered to remove candidates which the model(s) predict to be sufficiently close to the boundary. Any duplicate design points may then be replaced with points from the filtered set of candidate replacement design points.

The objective function d⁽ⁿ⁾(x) may be chosen to reflect a predicted distance from the boundary of the feasible region. The boundary B may be defined as B={x such that maxᵢ(\tilde{f}ᵢ(x)−Tᵢ)=0}, where \tilde{f}ᵢ(x) is the ground truth value of the i^{th} output and Tᵢ is the threshold value of the i^{th} output. In other words, the boundary may be defined as the set of points for which at least one constraint is active, and no constraint is violated. Observing that the functions sampled from the probabilistic model(s) are predicted values of the output(s), predictions of the boundary B are given by

$${B}^{( n )} = \{ x such that {max}_{i} ( {f}_{i}^{( n )} ( x ) - {T}_{i} ) = 0 \} .$$

The objective function d⁽ⁿ⁾(x) may be chosen to penalise a distance from the predicted boundary B⁽ⁿ⁾, which is expected to tend towards the true boundary B (locally or globally) as the accuracy of the probabilistic model(s) improves.

In the case of a single output, the objective function may be given by, or otherwise depend on, any suitable distance metric measuring a separation of the function output and the predicted boundary. For example, the objective function d⁽ⁿ⁾(x) for the n^{th} design point may be given by d⁽ⁿ⁾(x)=∥f⁽ⁿ⁾(x)−T|, where x denotes a point in the design space, f⁽ⁿ⁾(x) is the value of the function at the point x, T is the threshold value of the output of the physical system, and ∥·∥ denotes a distance metric, such as L1 distance, L2 distance, or smoothed L1 distance.

In cases where thresholds apply to multiple outputs of the physical system, an example of a suitable objective function is given by

$${d}^{( n )} ( x ) = {\vert {max}_{i} ( {f}_{i}^{( n )} ( x ) - {T}_{i} ) \vert}^{q} for q = 1 , 2 , …$$

To avoid possible numerical issues, the objective function may optionally be modified by rescaling one or more operands of the max operator by respective positive scaling factors scaleᵢ, such that

$${d}^{( n )} ( x ) = {\vert {max}_{i} ( [ {f}_{i}^{( n )} ( x ) - {T}_{i} ] / {scale}_{i} ) \vert}^{q} .$$

Other modifications are possible, for example replacing the max operator with a smooth approximation of the maximum operator, such as any one of the Boltzmann, LogSumEpx, mellowmax, p-Norm, or Smooth Maximum Unit (SMU) operators. These objective functions selectively penalise distances between the threshold values Tᵢ and the functions fᵢ in dependence on their relative values. By selectively penalising distances in this way, the objective function can induce design points to lie along the boundary of the feasible region, rather than being concentrated at intersections between boundary portions corresponding to different thresholds (as may be the case for penalising a sum of all such distances) or extending to manifolds far from the boundary of the feasible region (as may be the case for penalising a minimum such distance).

Another example of an objective function with suitable properties is given by

$${d}^{( n )} ( x ) = {min}_{1 \leq j \leq J} ( {\vert {f}_{j}^{( n )} ( x ) - {T}_{j} \vert}^{q} + {\sum }_{i \neq j} {max ( 0 , {f}_{i}^{( n )} ( x ) - {T}_{i} )}^{q} ) ,$$

where Tⱼ is the threshold value of the j^{th} output and q>0. For q=1 or q=2, this can equivalently be written as

$${d}^{( n )} ( x ) = {\sum }_{i} {max ( 0 , {f}_{i}^{( n )} ( x ) - {T}_{i} )}^{q} + {min}_{1 \leq j \leq J} ( {\vert {f}_{j}^{( n )} ( x ) - {T}_{j} \vert}^{q} - {max ( 0 , {f}_{j}^{( n )} ( x ) - {T}_{j} )}^{q} ) .$$

Optimisation of any of the objective functions described above from a given point in the design space will trace a path towards the predicted boundary of the feasible region. In FIG. 2, thick white arrows illustrate possible directions of a negative gradient of an objective function at various points within the design space.

The optimisation of the objective function may be applied globally across the entire design space, or alternatively may be applied locally for individual design points in the batch, for example within separate “trust regions” of the design space. For example, the n^{th} design point may be determined by optimising the corresponding objective function d⁽ⁿ⁾(x) with x constrained to lie within a respective trust region. Each trust region may be used to determine one or more design points, with different functions being sampled from the probabilistic model(s) for each design point in each trust region.

The trust regions may be subregions of the design space centred at different locations and each having a prescribed shape such as a hypersphere or hyperrectangle. The locations and dimensions of the trust regions may evolve between iterations, for example according to the method described in the article “Scalable Global Optimization via Local Bayesian Optimization” by Eriksson et al, Conference on Neural Information Processing, 2019. According to this method, the size of a given trust region may be increased after a predetermined number of “successes” in which the value of the objective function is improved between iterations, and may be decreased after a predetermined number of “failures” in which the value of the objective function is not improved between iterations. Whenever a trust region satisfies predetermined re-initialisation conditions, that trust region may be terminated, and a new trust region may be initialised.

In the present setting, the re-initialisation conditions may include, for example, the size of a trust region dropping below a threshold size, the objective function reaching zero (indicating a design point lying on the predicted boundary), a trust region becoming too close to another trust region, and/or the optimiser converging to a design point that has already been determined. These last two conditions may further help to promote diversity in the determined set of design points. In the present setting, it is advantageous for the new trust region to be initialised at a location that is predicted by the probabilistic model(s) to be close to the boundary of the feasible region, or which is otherwise expected to be close to the boundary of the feasible region, for example a location determined by randomly perturbing from a randomly selected design point determined at a previous iteration. Optimising the objective functions d⁽ⁿ⁾(x) locally in respective trust regions can result in local optima being identified along the estimated boundary of the feasible region, leading to more efficient exploration of the boundary, particularly for high-dimensional design spaces.

In some examples, the same probabilistic model (or the same set of probabilistic models) may be used to determine all of the design points in a given batch. In other implementations, different probabilistic models may be used to determine different design points in the batch. For example, N independent probabilistic models (or N independent sets of probabilistic models) may be responsible for respective different trust regions. In this way, at a given iteration each probabilistic model may only be responsible for predicting output(s) of the physical model for a relatively small region of the design space, which may result in a simpler optimization surface for fitting the probabilistic models, and may further improve the accuracy of the method and the scalability of the method to high-dimensional design spaces.

As discussed above, in some case the threshold value of one or more of the outputs of the physical system may not be known exactly during a stage of the design process. In this case, the objective functions described above may be modified such that the threshold values Tᵢ are sampled independently for each design point n in the batch. The threshold values may for example be sampled from probability distributions, such as uniform distributions over a given range of output values. By sampling the threshold values along with the functions, the method will result in design points being selected throughout the regions where the (currently indeterminate) boundaries of the feasible region may be. In the example of FIG. 2, it is observed that design points are selected throughout the regions 204a, 204b, 204c representing the uncertain boundaries of the feasible region 202.

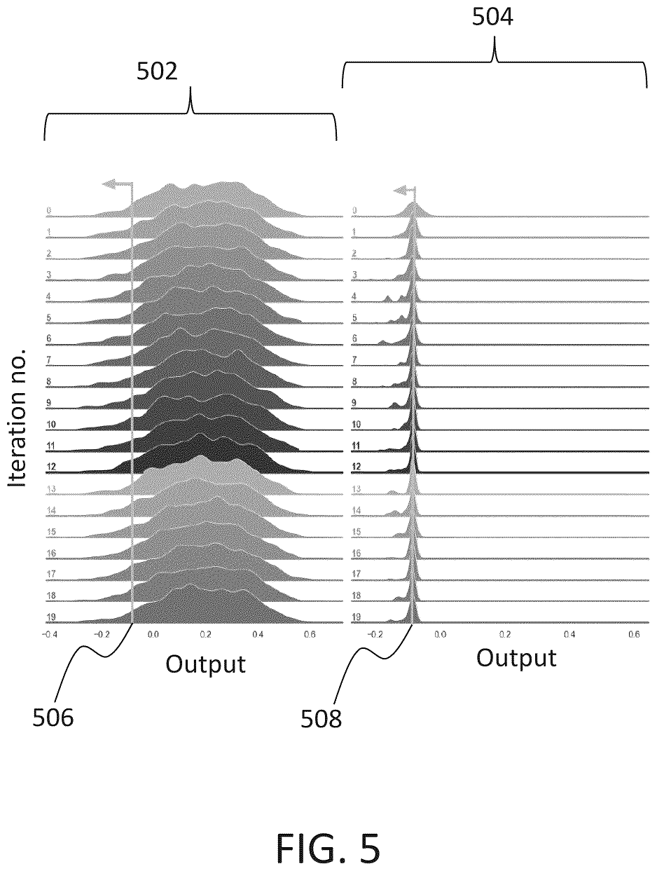

At early iterations, when the probabilistic models may have a relatively high variance, there is expected to be significant diversity in the sampled functions, so there will be significant diversity in the selected design points, thereby exploring large regions of the design space. At later iterations, when more empirical and/or simulated data has been collected, the probabilistic models may have significantly lower variance, in which case the diversity in the sampled functions will also be decreased, so and the selected design points will be concentrated around the boundaries of the feasible region, enabling the precise location of the boundaries of the feasible region to be predicted accurately. FIG. 5 shows results of twenty iterations of an illustrative experiment in which 1000 design points are selected at each iteration for a physical system with a single output subject to a threshold. The left frame 502 shows the distribution of output values for points selected at each iteration using Sobol sampling. It is observed that the distribution remains qualitatively similar between iterations, and is independent of the threshold value of the output (indicated by the vertical line 506). By contrast, the right frame 504 shows the distribution of output values for points selected at each iteration using the method described herein. In this case, even at the zeroth iteration, the distribution of output values is close to the threshold value (indicated by the vertical line 508), indicating that the probabilistic model as first initialised is able to make reasonably accurate predictions of the output values. The distribution becomes more sharply peaked around the threshold value at later iterations, as the probabilistic model becomes more confident in its predictions.

As explained above, the functions sampled at 304 are independent of one another, meaning that the corresponding objective functions can be optimized in parallel. As a result, large batches of design points (for example, thousands or tens of thousands of design points) can be determined in a relatively short amount of time. This is in contrast with other batch Bayesian optimisation methods which typically rely on a multi-point approach in which a batch of points is determined by optimising an acquisition function that attributes a single score to the entire batch, or a greedy approach in which an acquisition function is optimised to determine a first point, and then modified to penalise locations close to the first point before being optimised again to determine a second point, and so on until a desired number of points is obtained. At the time of writing, state of the art greedy typically become computationally infeasible for batches greater than around 20 points, while the sequential nature of the algorithms prevents parallelization. Multi-point algorithms tend to be highly computationally-intensive. The present sampling-based approach, by contrast, enables large batches of points to be determined in a parallelized fashion.

The method of FIG. 3 continues with obtaining, at 308, values of the outputs of the physical system at the design points determined at 306. As discussed above, this may include taking physical measurements of one or more prototypes of the physical system, and/or may include performing numerical simulations of the physical system. In some examples, raw data obtained at 308 may be processed, for example by normalisation and/or outlier removal prior to proceeding to the next step.

The method continues with updating, at 310, the probabilistic model(s) using the data obtained at 308. Updating the probabilistic model(s) may include determining updated values of the trainable parameters of the probabilistic model(s), for example using gradient-based optimisation with respect a maximum a posteriori or maximum likelihood objective function (which may be equivalent to maximising an ELBO). Determining the updated parameter values at a given iteration may involve running an optimisation procedure starting from the parameter values determined at the previous iteration (or during initialisation). In this way, the optimisation does not need to start from scratch each time and training can be faster. However, for at least some iterations updating the model(s) may include re-initialising the model(s) and retraining from scratch using all of the accumulated data.

The method continues with determining, at 312, whether a stopping condition is satisfied. The stopping condition may for example include one or more convergence criteria being satisfied and/or a predetermined number of iterations having taken place, or user input being provided. The stopping condition may be dependent on evaluations of the probabilistic model(s). For example, the stopping condition may be dependent on a metric evaluating the classification accuracy of the model(s), such as the Brier score or FI score. Alternatively, or additionally, the stopping condition may be dependent on a predicted variance associated with one, some, or all of the probabilistic models at a set of design points dropping below a given threshold. In this way, the uncertainty estimates built into the probabilistic model(s) can be used to self-assess the convergence of the model(s) at each iteration.

If the stopping condition is not satisfied, the method returns to step 304. The steps 304-310 continue iteratively until the stopping condition is satisfied, with new data being collected and the probabilistic model(s) being updated at each iteration. When the stopping condition is satisfied, the method of FIG. 3 concludes with predicting, at 314, the feasible region of the design space using the probabilistic model(s). Predicting the feasible region may include identifying regions of the design space in which the probabilistic model(s) predict the design points to meet a feasibility criterion, such as the predicted probability of feasibility being greater than 0.5 or another chosen value. To achieve this, the probabilistic model(s) may be used to evaluate the feasibility criterion at design points within the design space (for example, some or all of the design points selected during the preceding steps, or a new set of design points selected e.g. according to a space-filling design). A feasible region may be inferred from a cluster of design points meeting the feasibility criteria. Such regions may be presented via a user interface, for example using 2D or 3D plots in which certain dimensions are suppressed by marginalisation or in which values in certain dimensions are fixed.

In some examples, a user may wish to inspect a view or representation of the feasible region after one or more initial iterations, following which one or more further iterations may be carried out (as indicated by the dashed arrow in FIG. 3). In particular, a user may decide to tweak threshold values of one or more design variables in dependence on characteristics or an appearance of the feasible region after the initial iteration(s).

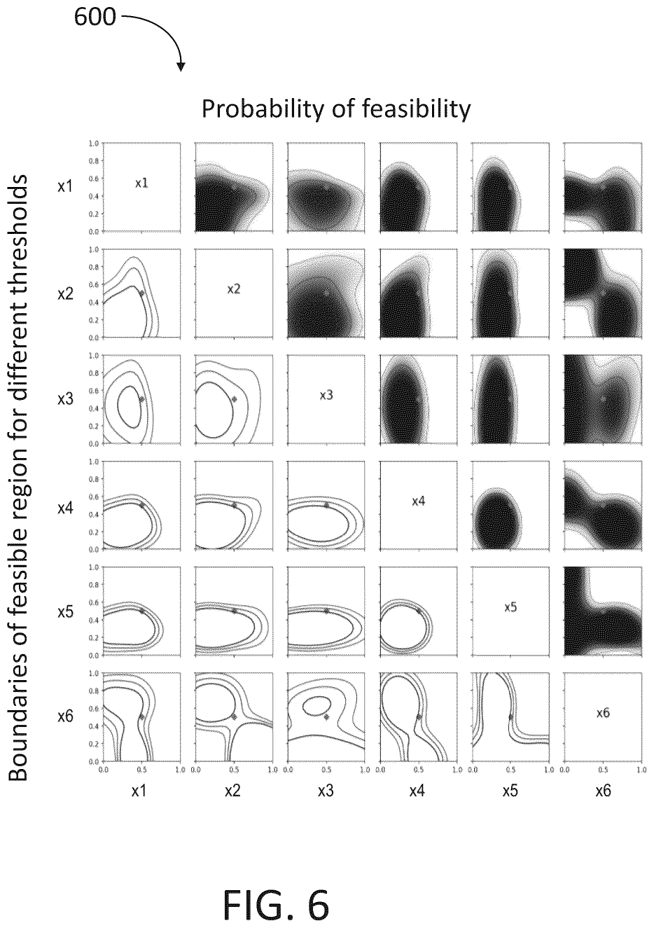

FIG. 6 shows an array of two-dimensional plots each displaying a respective two dimensions of a six-dimensional design space, in which values of the other four dimensions are fixed as coordinates of a slicing point (represented as a diamond-shaped point in the plots). The upper-right plots show the predicted probability of feasibility for given threshold values of the outputs, with darker shading corresponding to a higher probability of feasibility. The curves represent contours on which the estimated probability of feasibility is given by 90%, 50% and 10%. The curves in the lower-left plots represent contours on which the estimated feasibility is given by 50%, for the same threshold values of the outputs as above, and also for the threshold values varied by the.

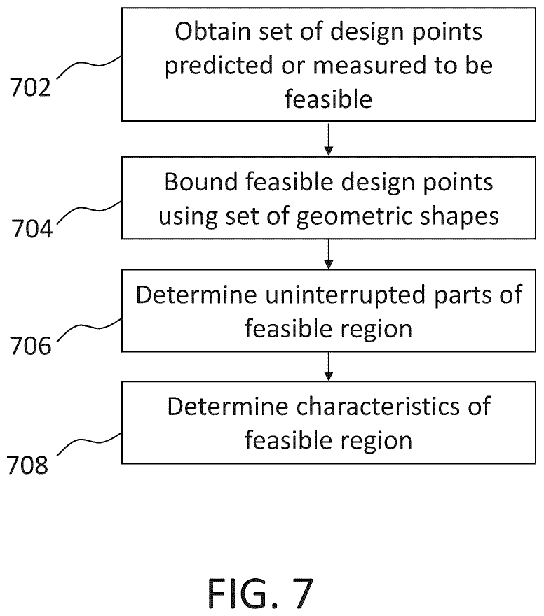

It can be a challenging task for users to detect and characterise feasible regions of a high-dimensional design space by manually exploring the design space using 2D or 3D plots. Therefore, an object of the present disclosure is to provide a method of automatically determining a representation of a feasible region of a design space, such as a feasible region predicted using the methods described above. Such a method is described with reference to FIG. 7. The method begins with obtaining, at 702, a set of design points predicted or measured to be feasible. The set of design points may for example include design points predicted or measured to be feasible based on experiments or simulations carried out during step 308 in one or more iterations of the method of FIG. 3. Alternatively, or additionally, the set of design points may include points predicted to be feasible based on one or more predictive models, such as probabilistic model(s) trained according to the method of FIG. 3. These probabilistic model(s) are capable of predicting probability distributions for the output(s) of the physical system at given design points, and may therefore be used to predict whether a given design point lies within a feasible region (i.e. whether a feasibility criterion is met). Other types of predictive model may simply predict values of the output(s) of the physical system at given design points, or may directly classify points as feasible or non-feasible. In any of these cases, the predictive model(s) may optionally be trained using data collected during the method of FIG. 3.

In order to obtain the set of predicted feasible design points using the predictive model(s), the predictive model(s) may be evaluated at a set of candidate design points, which may be selected randomly or deterministically, for example according to a space-filling method. However, for high-dimensional design spaces a very large number of candidate design points may be needed to obtain a sufficient set of predicted feasible design points. A preferable method may therefore to be to use the predictive model(s) to guide the selection of design points, for example using an optimisation procedure similar to that described in relation to step 306 of FIG. 3.

The method continues with bounding, at 704, the design points predicted or measured to be feasible using a set of geometric shapes having the same dimensionality as the design space. The shapes may include, for example, hyper-rectangles or other hyper-polygons, hyper-ellipses, or any combinations of any of these or other shapes. The number, location, orientation and dimensions of the geometric shapes may be determined algorithmically to most tightly bound the feasible region. Characteristics of the feasible region, such as its bounds in any given dimension, its (hyper) volume, and its shape, may be readily derived from parameter values of the set of geometric shapes. The shape of a feasible region may provide information on dependencies between design variables.

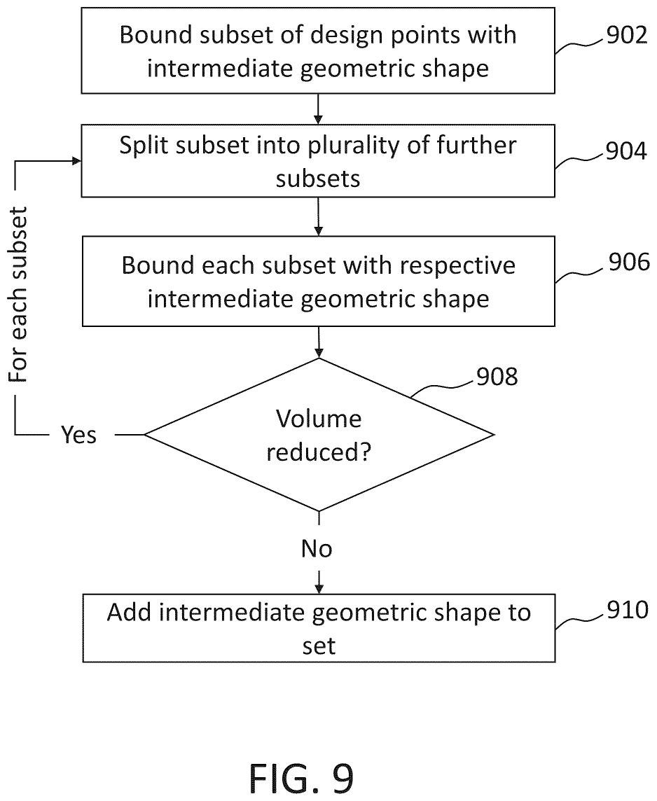

A method of bounding a set of predicted feasible design points by a set of geometric shapes is provided below with reference to FIG. 9.

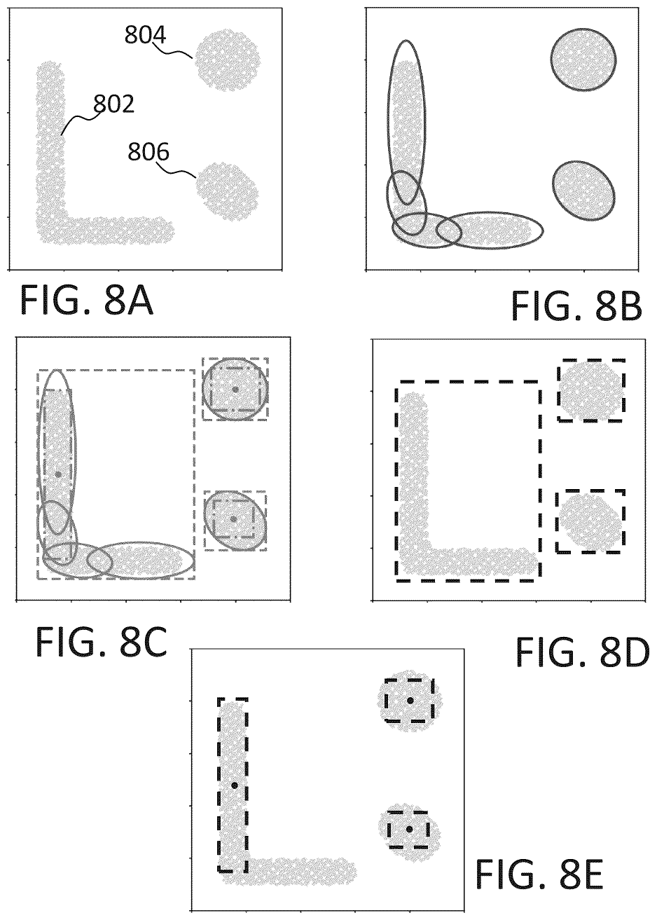

FIG. 8A shows an example of a two-dimensional design space for which a probabilistic model has been evaluated at design points throughout the design space. Design points predicted to be feasible are shown in three clusters 802, 804, 806, corresponding to the feasible region of the design space. FIG. 8B shows the clusters 802, 804, 806 bounded by a set of six ellipses.

The method continues with determining, at 706, connected or uninterrupted parts of the feasible region. This may be performed by determining which of the determined set of geometric shapes overlap or intersect, and grouping them accordingly. The grouping may be represented using a graph with nodes corresponding to the geometric shapes. If two shapes are determined to intersect, an edge is added between the shapes. When edges have been added for all pairs of intersecting shapes, each set of connected nodes of the graph represents an individual disjoint feasible portion of the design space. Algorithms for determining whether geometric shapes intersect are trivial for certain shapes (such as hyper-rectangles), and are also known for other shapes. For hyper-ellipses, the method outlined in the article “A robust computational test for overlap of two arbitrary-dimensional ellipsoids in fault-detection of Kalman filters” by Gilitschenski and Hanebeck, 15th International Conference on Information Fusion, 2012 may be used. As an example, FIG. 8B shows that the cluster 802 is bounded by a group of four intersecting ellipses.

The method concludes with determining, at 708, one or more characteristics of the feasible region of the design space. The characteristics may include, for example, the volume, shape, and/or centroid of an individual part of the feasible region or of a corresponding exterior bounding box. Additionally, or alternatively, the characteristics may include a centroid and dimensions of a largest interior axis-aligned bounding box. For a given set of intersecting geometric shapes, the largest interior axis-aligned bounding box may define a set of mutually independent constraints on individual design parameters, meaning that those design parameters can be varied independently within the corresponding ranges without necessarily needing to vary values of the other design parameters. Information indicative of characteristics such as the centroid, the exterior bounding box, and/or the largest interior axis-aligned bounding box may for example be output via a user interface or may be provided as an input to an automated downstream design process. Given the geometric shape description of a given feasible portion of the design space, it is possible to formulate detection of a largest interior axis-aligned bounding box as an optimisation problem, maximising the volume of a d-dimensional axis-aligned hypercube whilst ensuring that it does not contain any region of the design space outside the connected geometric shapes. As with many optimisation problems, it is possible for the optimiser to fall into a local minimum. This can be mitigated by optimising from a number of different starting points, and selecting the largest resulting hypercube. The different optimisation runs may optionally be parallelised.

In FIG. 8C, the regular dashed lines show (exterior) axis-aligned bounding boxes corresponding to the three separate clusters 802, 804, 806 (reproduced in FIG. 8D for clarity). The irregular dashed lines in FIG. 8C show largest interior axis-aligned bounding boxes corresponding to the clusters 802, 804, 806 (reproduced in FIG. 8E for clarity, along with the centroids of the largest interior axis-aligned bounding boxes).

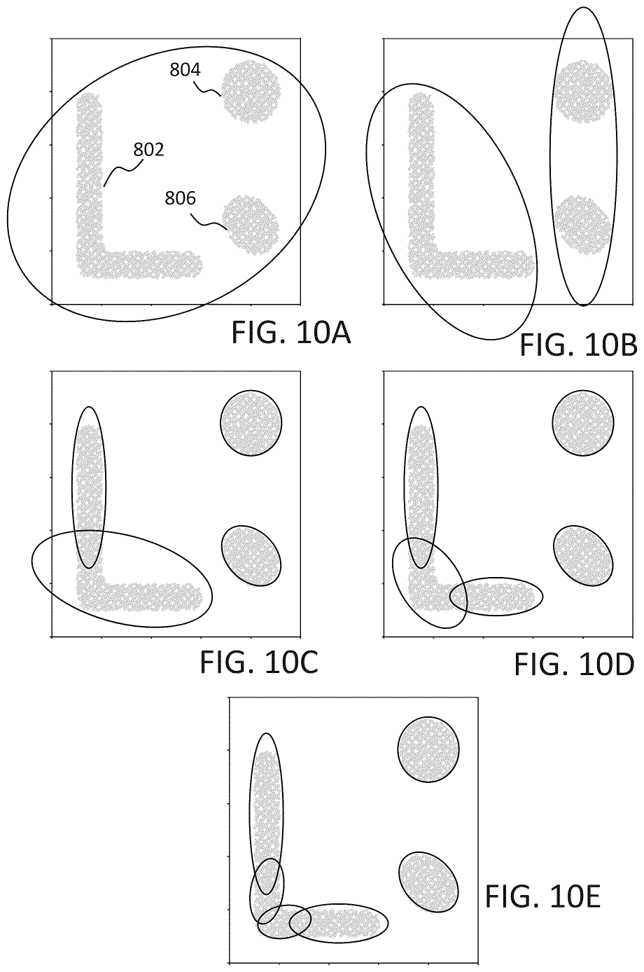

FIG. 9 shows an iterative method by which a subset of design points predicted to be feasible may be bounded by a set of geometric shapes. The method begins with bounding, at 902, the subset of design points with an intermediate geometric shape. At the first iteration of the method, the intermediate geometric shape may cover the entirety or a large proportion of the design space, and may be chosen to enclose all of the subset of points predicted to be feasible. The intermediate geometric shape may for example be a hyper-ellipse with equal dimensionality to the design space, though other shapes may be used. A hyper-ellipsoid may be defined by the equation (x−v)^{τ}A(x−v)<1, where v is the centroid (mean) and A is the covariance matrix of the hyper-ellipse. FIG. 10A shows an example of a two-dimensional ellipse covering the majority of the design space of FIG. 9. It is observed that the ellipse encloses all of the design points in the clusters 802, 804, 806.

The method of FIG. 9 continues with splitting, at 904, the subset of points into a multiple subsets of points in dependence on the intermediate geometric shape. The splitting or decomposing may be performed by clustering the points (for example using K-means clustering) at two or more cluster centres at locations depending on the intermediate geometric shape. In an example where the intermediate geometric shape is a hyper-ellipse, two K-means cluster centres may be initialised at the end points of the major axes of the hyper-ellipse. In an example where the intermediate geometric shape is a hyper-rectangle, two K-means cluster centres may be initialised at the centres of respective ends of the hyper-rectangle. In other examples, alternative clustering methods such as mean-shift clustering or density-based spatial clustering of applications with noise (DBSCAN) may be used.

The method continues with bounding, at 906, each of the subsets of points resulting from the split using respective intermediate geometric shapes, and determining, at 908, whether the intermediate geometric shapes determined at 906 occupy an overall smaller volume than the intermediate geometric shape determined at 902, or in other words whether the splitting has resulted in a reduction of volume of intermediate geometric shapes. If the volume has decreased, then the method returns to 904 for each subset of points resulting from the split at 904. If the volume has not decreased, then the intermediate geometric shape bounding the subset of points before the split is added to the set of geometric shapes. When no further reduction of volume results from splitting any of the remaining subsets, the method concludes, and the set of geometric shapes is complete.

In the example of FIG. 10B, the cluster 802 is split from the cluster 804 and 806, and the resulting subsets of points are bounded by two ellipses. In subsequent FIGS. 10C-10E, the resulting subsets are further split and bounded by further ellipses until no reduction of volume would result from further splitting. The set of ellipses remaining in FIG. 10E is a representation of the feasible region occupied by the clusters 802, 804, 806.

Variants of the method of FIG. 9 are possible, for example in which infeasible design points are explicitly excluded from the representation of the feasible region, as opposed to simply bounding feasible points. The method of FIG. 9 may be implemented, for example, using part of the open-source Dynesty software package, as described in the article “dynesty: A Dynamic Nested Sampling Package for Estimating Bayesian Posteriors and Evidences” by J. Speagle, MNRAS (2019), in which an algorithm for iteratively decomposing hyper-ellipses is presented for used in a different context, namely for nested sampling to estimate posterior distributions and evidences for Bayesian inference.

At least some aspects of the examples described herein with reference to FIGS. 1-10 comprise computer processes or methods performed in one or more processing systems and/or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example a hard disk; optical memory devices in general; etc.

The above embodiments are to be understood as illustrative examples of the invention. Further embodiments of the invention are envisaged. For example, the methods described above for determining a representation of a feasible region of the design space may be performed independently of the iterative sample-based methods of training probabilistic model(s). The probabilistic model(s) may alternatively be obtained in any other suitable manner, for example by fitting the probabilistic model(s) to a single dataset of empirical or simulated values, and/or constructed based on physical principles. Furthermore, the method of determining a representation of a feasible region may be performed using any type of model, including deterministic models, that are capable of predicting whether a design point is feasible.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A system comprising at least one processor and at least one non-transitory storage medium storing instructions which, when executed by the at least one processor, cause the at least one processor to carry out operations comprising:
for one or more iterations:
determining a set of design points within a design space for a physical system, wherein determining a given design point in the set comprises:
for one or more outputs of the physical system, sampling respective functions from respective probabilistic models each having a set of trainable parameters, wherein the respective functions predict values of the one or more outputs at design points within the design space; and
selecting the given design point based on an objective function that penalises a distance from a boundary of the feasible region as predicted by values of the respective functions,
obtaining data comprising values of the one or more outputs of the physical system at each design point of the determined set of design points; and
determining, using the obtained data, updated values of the set of trainable parameters; and
after the one or more iterations, predicting a feasible region of the design space using the data obtained during the one or more iterations.

2. The system of claim 1, wherein the predicting of the feasible region of the design space uses the respective probabilistic models for the one or more outputs of the physical system.

3. The system of claim 1, wherein:
the boundary of the feasible region depends on a variable threshold value of one of the outputs of the physical system; and
selecting the given design point comprises sampling the variable threshold value from a distribution of threshold values to predict the distance from the boundary of the feasible region.

4. The system of claim 1, wherein obtaining the data comprises executing simulations of the physical system at the determined set of design points.

5. The system of claim 1, wherein the obtaining of the data is carried out in parallel for at least some of the design points in the set.

6. The system of claim 1, wherein for a given iteration, determining each design point in the set comprises optimising a respective objective function within a respective trust region of the design space, the respective trust regions differing between at least some design points in the set.

7. The system of claim 1, wherein for the given iteration, determining each design point in the set uses a respective group of one or more probabilistic models, the respective groups corresponding to the respective trust regions of the design space.

8. The system of claim 1, wherein the probabilistic model comprises at least one of a Gaussian process regression model, a sparse Gaussian process, a deep Gaussian process, a Bayesian neural network, and a deep ensemble.

9. The system of claim 1, wherein the operations further comprise:
either:
obtaining, using the respective probabilistic models for the one or more outputs of the physical system, a plurality of design points predicted to lie within the feasible region of the design space, or
obtaining, based on the data obtained during the one or more iterations, a plurality of design points predicted or measured to lie within the feasible region of the design space; and
bounding the plurality of design points using a set of geometric shapes of equal dimensionality to the design space, thereby to determine a representation of the feasible region of the design space.

10. The system of claim 9, wherein the operations further comprise:
determining an uninterrupted at least part of the feasible region of the design space by identifying a connected at least subset of the set of geometric shapes;
determining, for the uninterrupted at least part of the feasible region of the design space, at least one of a hypervolume, an exterior axis-aligned bounding box, and a largest interior axis-aligned bounding box; and
outputting, via a user interface, information indicative of said at least one of a hypervolume, an exterior axis-aligned bounding box, and a largest interior axis-aligned bounding box.

11. The system of claim 1, wherein:
the one or more outputs of the physical system is a plurality of outputs; and
the objective function selectively penalises distances between the respective functions and the respective threshold values of the plurality of outputs.

12. The system of claim 1, wherein the selective penalising is selective in dependence on the distances between the respective functions and the respective threshold values of the plurality of outputs.

13. The system of claim 1, wherein the physical system comprises at least part of a vehicle.

14. The system of claim 13, wherein the at least part of the vehicle comprises one or more of a hybrid powertrain system, a vehicle architecture, an electric motor, a battery system, a thermal management system, a regenerative braking system, a tyre, and an aerodynamic component.

15. The system of claim 1, wherein the respective functions sampled for any given design point in the set are independent from the function or functions used to determine any other given design point in the set.

16. The system of claim 1, wherein the selecting of at least some of the design points in the set is carried out in parallel.

17. A method comprising:
for one or more iterations, using one or more processors:
determining a set of design points within a design space for a physical system, wherein determining a given design point in the set comprises:
for one or more outputs of the physical system, sampling respective functions from respective probabilistic models each having a set of trainable parameters, wherein the respective functions predict values of the one or more outputs at design points within the design space; and
selecting the given design point based on an objective function that penalises a distance from a boundary of the feasible region as predicted by values of the respective functions,
obtaining data comprising values of the one or more outputs of the physical system at each design point of the determined set of design points; and
determining, using the obtained data, updated values of the set of trainable parameters; and
after the one or more iterations, predicting a feasible region of the design space using the data obtained during the one or more iterations.

18. The method of claim 17, further comprising manufacturing a prototype of the physical system with values of the design parameters falling within the predicted feasible region of the design space.

19. The method of claim 17, further comprising:
either:
obtaining, using the respective probabilistic models for the one or more outputs of the physical system, a plurality of design points predicted to lie within the feasible region of the design space, or
obtaining, based on the data obtained during the one or more iterations, a plurality of design points predicted or measured to lie within the feasible region of the design space;
bounding the plurality of design points using a set of geometric shapes of equal dimensionality to the design space, thereby to determine a representation of the feasible region of the design space; and
manufacturing a prototype of the physical system with values of the design parameters falling within the feasible region of the design space as indicated by the determined representation of the feasible region.

20. At least one non-transitory storage medium comprising instructions which, when executed by a computer, cause the computer to carry out operations comprising:
for one or more iterations:
determining a set of design points within a design space for a physical system, wherein determining a given design point in the set comprises:
for one or more outputs of the physical system, sampling respective functions from respective probabilistic models each having a set of trainable parameters, wherein the respective functions predict values of the one or more outputs at design points within the design space; and
selecting the given design point based on an objective function that penalises a distance from a boundary of the feasible region as predicted by values of the respective functions,
obtaining data comprising values of the one or more outputs of the physical system at each design point of the determined set of design points; and
determining, using the obtained data, updated values of the set of trainable parameters; and
after the one or more iterations, predicting a feasible region of the design space using the data obtained during the one or more iterations.
